(19) United States
(12) Patent Application Publication
(10) Pub. No.: US 2020/0160565 A1
(43) Pub. Date: May 21, 2020

(54) Methods And Apparatuses For Learned Image Compression

(71) Applicants: Zhan Ma, Fremont, CA (US); Haojie Liu, Nanjing (CN); Tong Chen, Nanjing (CN); Qiu Shen, Nanjing (CN); Tao Yue, Nanjing (CN)

(72) Inventors: Zhan Ma, Fremont, CA (US); Haojie Liu, Nanjing (CN); Tong Chen, Nanjing (CN); Qiu Shen, Nanjing (CN); Tao Yue, Nanjing (CN)

(21) Appl. No.: 16/689,062

(22) Filed: Nov. 19, 2019

Related U.S. Application Data
(60) Provisional application No. 62/769,546, filed on Nov. 19, 2018.

(51) Int. Cl. G06T 9/00; G06N 3/04; H04N 19/90

(52) U.S. Cl. CPC G06T 9/002; G06N 3/0472; H04N 19/90; G06N 3/0454

(57) ABSTRACT

A learned image compression system increases compression efficiency by using a novel conditional context model with embedded autoregressive neighbors and hyperpriors, which can accurately estimate the entropy rate for rate distortion optimization. Generalized Divisive Normalization (GDN) in Residual Neural Network is used in the encoder and decoder networks for fast convergence rate and efficient feature representation.

### CROSS-REFERENCE TO RELATED APPLICATIONS

This application claims priority to the following patent application, which is hereby incorporated by reference in its entirety for all purposes: U.S. Patent Provisional Application No. 62/769546, filed on Nov. 19, 2018.

### TECHNICAL FIELD

This invention relates to learned image compression, particularly methods and systems using deep learning and convolutional neural networks for image compression.

### BACKGROUND

The explosive growth of image/video data across the entire Internet poses a great challenge to network transmission and local storage, and puts forward higher demands for high-efficiency image compression. Conventional image compression methods (e.g., JPEG, JPEG2000, High-Efficiency Video Coding (HEVC) Intra Profile based BPG, etc.) exploit and eliminate the redundancy via spatial prediction, transform and entropy coding tools that are handcrafted. These conventional methods can hardly break the performance bottleneck due to linear transforms with fixed bases, and a limited number of prediction modes.

Learned image compression methods were introduced to improve coding efficiency recently. Learned image compression methods usually depend on recurrent or variational auto-encoders, which can train image compression architectures in an end-to-end manner. Typical learned image compression algorithms contain several key components such as convolution based transform and nonlinear activations (or nonlinear transform for short), differentiable quantization and context-adaptive entropy coding. Different quality measurements as loss functions can be applied in such learned image compression framework to improve the subjective quality of reconstructed images.

Among them, nonlinear transform is one of the important components affecting compression efficiency. Several nonlinear activations, such as ReLU (rectified linear unit), sigmoid, tanh, parametric ReLU (PReLU), are used together with the linear convolutions. Convolutions, which are referred to as the “Cony” for short, are used to weigh local neighbors for information aggregation. Its kernel is derived by the end-to-end learning. However, conventional nonlinear activation functions, such as ReLU and PReLU, could not well leverage the frequency selectivity of the human visual system (HVS) to reduce the image redundancy. Further, regular convolution may fail in learning due to the difficulties in convergence.

### BRIEF SUMMARY

In one embodiment of the learned image compression system, variational auto-encoders can be used to transform raw pixels into compressible latent features. The compressible latent features are then converted using a differentiable quantization method into quantized feature maps. A learning-based probability model is then applied to encode the quantized feature maps into binary bit streams. A symmetric transform is used to decode the bit streams to obtain the reconstructed image.

In one embodiment of this invention, Generalized Divisive Normalization (GDN) in Residual Neural Network (ResNet), which is so referred to as Residual GDN or ResGDN, is used for fast convergence during training of the information compensation network (ICN) to fully explore the information contained in hyperpriors and the gated 3D context model for better entropy probability estimation and parallel processing.

The learned image compression system comprise an encode framework and a decoder framework. In one embodiment, the encoder framework includes a Main Encoder Network E, a Hyper Encoder Network he, a Gated 3D context model P, quantization Q, and an Arithmetic Coder AE. The encoder framework encodes the raw pixels into main bit streams and hyper bit streams, respectively.

In another embodiment, the decoder framework uses a network structure that is symmetric to the one of the encoder framework, including a Main Decoder Network D, a Hyper Decoder Network h_{d}, the same Gated 3D context model P, an Information Compensation

Network (ICN) I, and an Arithmetic Decoder AD. The decoder framework generates the reconstructed image from encoded binary bit streams.

In one embodiment, the encoder framework can take different image formats as inputs such as RGB or YUV data with multiple (such as three) input channels. The input images can also include grayscale images or hyperspectral images with various input channels. Different networks can be also used in this encoder framework (e.g., DenseNet, or Inception network). Residual GDN or ResGDN is used in the encoder and decoder frameworks by embedding GDN in ResNet.

In one embodiment, residual GDN or ResGDN is used in both Main Encoder Network and Main Decoder Network for faster convergence during training. ResGDN is superior in terms of modeling image density as compared to other nonlinear activations and can achieve at least 4x convergence rate of other nonlinear activations. ResGDN also achieves performance improvement while maintaining similar computational costs as other nonlinear activations.

In another embodiment, the Main Decoder Network in the decoder framework includes concatenation features, e.g., concatenating information from ICN I and parsed latent features for image decoding.

In a further embodiment, decoded hyper features are processed by ICN I prior to being concatenated with the main quantized features to be decoded into the reconstructed image. During training, ICN can dynamically adjust the hyperpriors to allocate bits for probability estimation or reconstruction. For example, ICN can include three residual blocks and the convolutions in the residual blocks can have a kernel size of 3×3. Other network settings, e.g., different convolutional kernel size, and different number of residual blocks, can be used in ICN as well.

In one embodiment, the 3D context model P is used to further exploit the redundancy in the quantized feature maps for better probability estimation using autoregressive neighbors and hyperpriors. For example, a gated 3D separable context model can be used, which can predict the current pixel using neighbors from channel stack, vertical stack and horizontal stack in parallel. The entire neighbors of previous pixels in a 3D cubic can be used, which eliminate the blind spots and obtain better prediction.

In one embodiment, the predicted features based on the Gaussian distribution assumption is used for rate estimation. Different distribution assumptions, such as Laplacian distribution can also be used.

In one embodiment, an arithmetic coder is used to remove statistical redundancy in quantized features maps. In another embodiment, an arithmetic decoder is used to convert binary bits into reconstructed quantized feature maps.

In one embodiment, hyperparameters in image codec are derived via an end-to-end learning. The learning is performed to minimize the rate-distortion loss and to determine the parameters using available sources including public images.

In one embodiment, the overall training process should follow the rate-distortion optimization rules. Mean Square Error (MSE) and multi-scale similarity (MS-SSIM) can be used as image distortion measurements. Other distortion measurements, such as adversarial loss, perceptual loss, can be applied as well.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a block diagram that illustrates an example of the learned image compression system.

FIG. 2 is a block diagram that illustrates an example of a residual block used in Information Compensation Network (ICN).

FIG. 3 is a block diagram that illustrates an example of the residual GDN (ResGDN).

FIG. 4 is a block diagram that illustrates an example of a 3D prediction model used in the Gated 3D context model.

FIG. 5 is a block diagram that illustrates an example of the Gated 3D context model.

FIG. 6 is a diagram illustrating various components that may be utilized in an exemplary embodiment of the electronic devices wherein the exemplary embodiment of the present principles can be applied.

### DETAILED DESCRIPTION

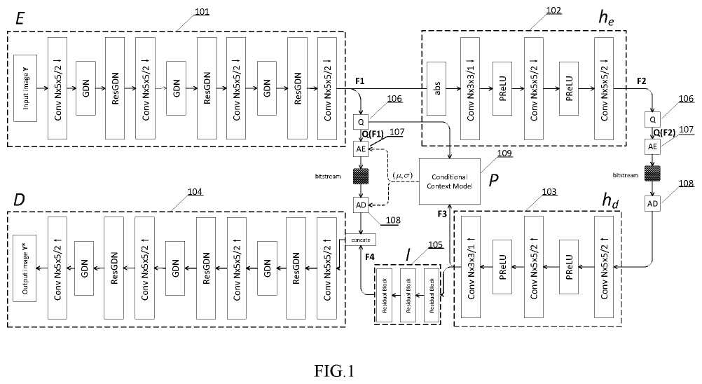

FIG. 1 illustrates an embodiment of the learned image compression system and process. For encoding, the learned image compression system first provides input image Y to the Main Encoder Network 101 (E) to generate the down-scaled feature maps F1. F1 is provided to the Hyper Encoder Network 102 (hₑ) to generate more compact feature maps F2. Stacked deep neural networks (DNNs) utilizing serial convolutions and nonlinear activation are used in both 101 and 102. Non-linear activation functions, such as ReLU (rectified linear unit), PReLU, GDN and ResGDN, map each input pixel to an output. In FIG. 1, GDN and ResGDN are applied in Main Encoder Network 101 and PReLU is used in Hyper Encoder Network 102. Notably, Generalized Divisive Normalization (GDN) based nonlinear transform better preserves the visual sensitive components as compared to other aforementioned nonlinear activations. Thus, GDN can be used to replace or supplement traditional ReLU functions embedded in deep neural network. The quantization 106 is applied to the feature maps F1 and F2 to obtain the quantized features Q(F1) and Q(F2). The arithmetic encoding 107 (AE) is used to encode the quantized feature maps into the binary bit streams based on the probability distribution calculated from the P 109. The arithmetic decoding 108 (AD) is then applied to the binary bit streams to reconstruct the quantized features losslessly.

For decoding, the Hyper Decoder Network 103 (h_{d}) is used to decode the hyperpriors Q(F2) into hyper decoded features F3 at the same dimensional size as the latent features generated from the Main Encoder E for latent feature probability estimation in the Gated 3D context model P 109. The information compensation network (ICN) 105 (I) can transform hyper decoded features F3 into compensated hyper features F4 for information fusion before the final reconstruction. The main quantized features Q(F1) is then concatenated with compensated hyper features F4 and the concatenation is then decoded by the Main Decoder Network 104 (D) to derive the reconstructed image. The Gated 3D context model P 109 is used to provide the probability matrix based on Gaussian distribution assumption for arithmetic coding. For each pixel, it takes the hyper decoded features F3 and autoregressive neighbors in quantized latent features Q(F1) as input and outputs the mean and variance assuming the Gaussian distributed feature elements. The mean and variance have the same dimension as the quantized latent features Q(F1), so it can provide the independent probability for each pixel in the quantized latent features Q(F1).

In the embodiment depicted in FIG. 1, the Main Encoder Network 101 (E) includes four convolutional layers (Cony N×5×5/2↓), three GDN layers, and three ResGDN layers. Different layers and different number of layers can be applied as well. The convolutional layers denoted as Cony N×5×5/2↓ have N kernels each having a size of 5×5, followed by a down sampling at a factor of 2 at both horizontal and vertical directions. Conversely, in Hyper and Main Decoder Networks 103 and 104, four convolutional layers (Cony N×5×5/2↑) are applied, which each have N kernels each having a size of 5×5, followed by an up sampling with stride 2 for both horizonal and vertical directions. N can be set as 192 and the kernel size and scaling factor can be 5×5 and 2 for an example. They can have other settings as well.

The Hyper Encoder Network 102 applies absolution function (abs) to the feature map (F1) output from the Main Encoder Network 101, followed by three convolutional layers and two PReLU layers. As an example, one Cony N×3×3/1↓, layer is used, which denotes N kernels at a size of 3×3 followed by a 1× downscaling, followed by two Cony N×3×3/2↑ layers, which denote N kernels at a size of 3×3 followed by a 2× upscaling at both horizonal and vertical directions.

Main Decoder Network 104 and Hyper Decoder Network 103 can each have a structure symmetric to Main Encoder Network 101 and Hyper Encoder Network 102 respectively. Correspondingly, downscaling at Encoders is set to use the same scaling factor as upscaling at the Decoders.

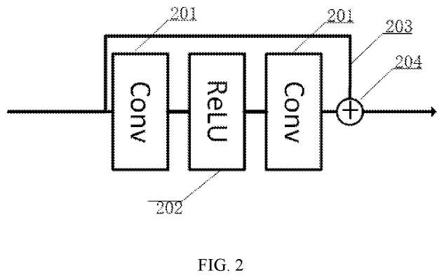

Three residual blocks are cascaded consecutively to form the ICN module 105 in the embodiment depicted in FIG. 1. FIG. 2 illustrates an example of such residual block, which uses two convolutional layers 201 with kernels having a size of 3×3 as an example, and one ReLU activation layer 202. Residual link 203 sums up the original and convoluted features element-wisely at 204 for the final output. Different numbers of residual blocks can be utilized as well, depending on various factors including the implementation requirements and cost considerations.

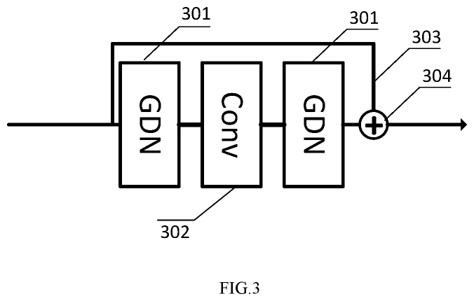

FIG.3 illustrates an embodiment of ResGDN used in the learned image compression framework. It comprises two GDN layers 301 and one convolutional layer 302, which are then element-wisely summed up with the original information via the residual connection 303. Note that input features and output features have the same dimension after the transformation. The convolutional layer, for example, can have 192 kernels, which represent 192 different convolutional filters. The number of kernels can be different based on different computation capacity and requirement of the system, such as 128, 64 and 32. The convolutional kernel size can be 5×5, 3×3 or others, depending on factors including the implementation costs.

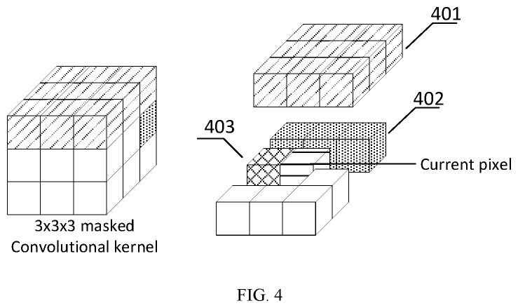

Entropy context modeling is important for efficient compression. Both autoregressive neighbors and hyperpriors are used for the context model in P 109. Quantized latent feature maps Q(F1) and decoded hyper feature maps (F3) are concatenated together for context modeling. To exploit the correlation between neighboring feature elements as much as possible, a 3D prediction model is used. Due to the limitation of casual prediction, any unprocessed future information beyond the position of current pixel is not allowed. A 3×3×3 3D prediction model is illustrated in FIG. 4, where a mask is applied to ensure casual prediction of current pixel from its previous positions at channel stack 401, vertical stack 402 and horizontal stack 403. Different sizes of 3D prediction, other than 3×3×3, can be applied as well. There are a variety of combinations to implement the context prediction for the current pixel using information from the previous pixel positions across channel, vertical and horizontal stacks, such as directly weighting all available pixels. To ensure parallel processing, a Gated 3D separable context model is applied, where predictions are first performed for channel, vertical and horizontal neighbors separately, followed by concatenation of the predictions.

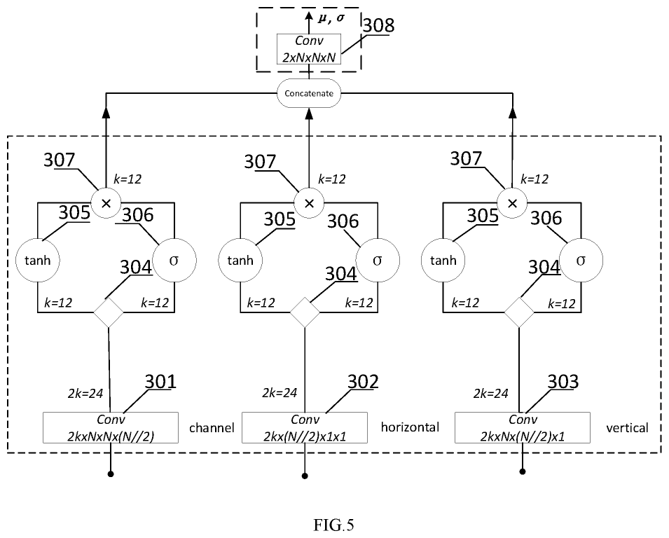

FIG.5 illustrates an embodiment of the Gated 3D separable context model for entropy probability estimation in the Gated 3D context model (P). A 3D N×N×N convolution kernel with a mask can be split into (N×N×N//2) 301, (N×N//2×1) 303, and (N//2×1×1) 302 convolutional branches via appropriately padding and cropping. N//2 is applying the floor operator to derive integer result, e.g., 3//2=1, 5//2=2. Mask is applied to ensure the casual prediction, where 301 is to access causal neighbors from channel stack, 302 to access the casual neighbors from horizontal stack, and 303 to access the casual neighbors from vertical stack. The number of convolutional filters used for all branches is 2k. k for example can be 12. Convolutional branches 301, 302 and 303 can run in parallel or sequentially.

For all feature maps derived from 301, 302, and 303, a splitting operator 304 is applied to divide feature channels equally into two channels, one of which will be activated using tanh function in 305, and the other using sigmoid function in 306. Element-wise multiplication is performed in 307 to process the activated features from 305 and 306 to generate aggregated information. Such gated information aggregation is applied for channel, vertical, and horizontal neighbor stacks in parallel in each convolutional branch, followed by a concatenation process to concatenate all information. An additional convolutional layer is then applied to aggregate information using a convolution with two filters, each having a kernel size of N×N×N, which yields the final context feature map at a size of H*W*C*2 to predict the mean and variance of the current pixel. The mean and variance feature maps share the same dimension as the latent feature (F1) at a size of H*W*C, with H denoting the height, W denoting the width, and C denoting the total number of channels of feature maps.

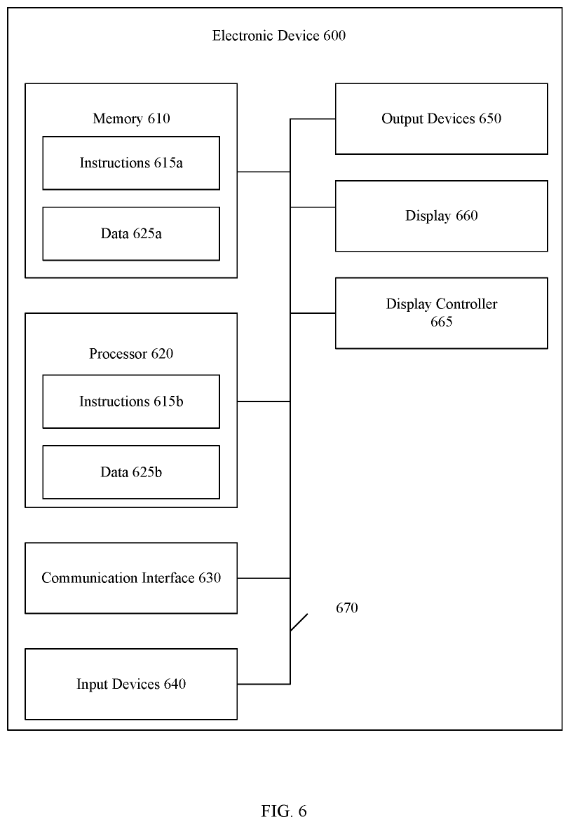

FIG. 6 illustrates various components that may be utilized in an electronic device 600. The electronic device 600 may be implemented as one or more of the electronic devices (e.g., electronic devices 101, 102, 103, 104, 105, 109) described previously.

The electronic device 600 includes a processor 620 that controls operation of the electronic device 600. The processor 620 may also be referred to as a CPU. Memory 610, which may include both read-only memory (ROM), random access memory (RAM) or any type of device that may store information, provides instructions 615a (e.g., executable instructions) and data 625a to the processor 620. A portion of the memory 610 may also include non-volatile random access memory (NVRAM). The memory 610 may be in electronic communication with the processor 620.

Instructions 615b and data 625b may also reside in the processor 620. Instructions 615b and data 625b loaded into the processor 620 may also include instructions 615a and/or data 625a from memory 610 that were loaded for execution or processing by the processor 620. The instructions 615b may be executed by the processor 620 to implement the systems and methods disclosed herein.

The electronic device 600 may include one or more communication interfaces 630 for communicating with other electronic devices. The communication interfaces 630 may be based on wired communication technology, wireless communication technology, or both. Examples of communication interfaces 630 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 600 may include one or more output devices 650 and one or more input devices 640. Examples of output devices 650 include a speaker, printer, etc. One type of output device that may be included in an electronic device 600 is a display device 660. Display devices 660 used with configurations disclosed herein may utilize any suitable image projection technology, such as a cathode ray tube (CRT), liquid crystal display (LCD), light-emitting diode (LED), gas plasma, electroluminescence or the like. A display controller 665 may be provided for converting data stored in the memory 610 into text, graphics, and/or moving images (as appropriate) shown on the display 660. Examples of input devices 640 include a keyboard, mouse, microphone, remote control device, button, joystick, trackball, touchpad, touchscreen, lightpen, etc.

The various components of the electronic device 600 are coupled together by a bus system 670, which may include a power bus, a control signal bus and a status signal bus, in addition to a data bus. However, for the sake of clarity, the various buses are illustrated in FIG. 6 as the bus system 670. The electronic device 600 illustrated in FIG. 6 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein (e.g., FIGS. 2-5) may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A system for learned image compression of one or more input images using deep neural networks (DNNs), comprising:
a main encoder network configured to convolute said input images into feature maps (fMaps) using DNNs, wherein each pixel of said fMaps describing coefficient intensity on said pixel; wherein said main encoder network comprising Generalized Divisive Normalization (GDN) -based nonlinear activations;
a hyper encoder network configured to convolute fMaps generated from the main encoder network into hyper fMaps using DNNs; wherein said hyper encoder network comprising regular nonlinear activations;
a context probability estimation model based on three-dimensional masked convolutions to access neighboring information of the pixel from a channel dimension, a vertical dimension and a horizontal dimension;
one arithmetic encoder configured to convert each pixel in fMaps modeled by the 3D masked convolutions into a bit stream;
another arithmetic encoder configured to convert each pixel in hyper fMaps into a bit stream.

2. The system of claim 1, wherein said GDN-based nonlinear activations comprises Generalized Divisive Normalization (GDN) in Residual Neural Network (ResNet) configured for fast convergence during training.

3. The system of claim 1 further comprising:
an arithmetic decoder configured to convert the bit stream generated by the arithmetic coder into fMaps,
a hyper decoder network having a symmetric network structure as the hyper encoder network and configured to decode hyper fMaps into decoded hyper fMaps;
an information compensation network configured to convolute decoded hyper fMaps from said hyper decoder into compensated hyper fMaps, said compensated hyper fMaps is then concatenated with decoded fMaps from said hyper decoder network;
a main decoder network having a symmetric network structures as the main encoder network and configured to convolute the concatenation of said compensated hyper fMaps and decoded fMpas to reconstruct input images.
